(19) United States
(12) Patent Application Publication
(10) Pub. No.: US 2009/0110172 A1
(43) Pub. Date: Apr. 30, 2009

(54) METHOD OF QUEUING AND RETURNING CALLS TO AN INTERACTIVE VOICE RESPONSE SYSTEM

(76) Inventors: MUSA RAOUL UNMEHOPA, Amersfoort (NL); Kumar Venkata Vemuri, Cambridge, MA (US)

Correspondence Address: MARK W. SINCELL;Williams, Morgan & Amerson, P.C., Suite 1100, 10333 Richmond, Houston, TX, 77042, US

(21) Appl. No.: 11/924,669

(22) Filed: Oct. 26, 2007

(51) Int. Cl. H04M 3/42

(52) U.S. Cl. 379/210.01

(57) ABSTRACT

The present invention provides a method for queuing and returning calls in an interactive voice response system. The method may include storing information indicating a phone number of a calling party in response to the calling party initiating a call to a destination phone number that is a begin-hunt number for a hunt group including a plurality of channels. The method also includes providing a first message to the calling party in response to determining that the channels are busy. The first message indicates that the call to the destination phone number has been placed in a queue associated with the plurality of channels. The first message also indicates that the calling party can elect to receive a call-back at the stored phone number of the calling party when one of the channels becomes available.

### BACKGROUND OF THE INVENTION

1. Field of the Invention

This invention relates generally to communication systems, and, more particularly, to interactive voice response systems in communication systems.

2. Description of the Related Art

Many businesses maintain extensive support centers for providing information to their customers. For example, an Internet service provider (ISP) may offer customer support to customers who contact the Internet service provider by calling a toll-free number. The customer may therefore call the toll-free number and be connected to an operator or other support personnel who can assist the customer with their question. One conventional technique for routing calls to individual operators is known as multi-line hunting. In this technique, communication channels to each of the operators are combined to form a hunt group and the communication channels in the hunt group are linked to the begin-hunt telephone number, i.e., the toll-free number for the customer support center. When a call to the begin-hunt number is received, the system searches through the hunt group members until an idle channel is found. The calling party is then connected to one of the operators over the idle channel. If no idle channels are found, then the calling party may be placed on hold until a channel becomes free.

An interactive voice response (IVR) system may be used to automate interaction with calling parties, e.g., in cases where the calling party must be placed on hold because there are no idle channels. The IVR system is typically implemented in a computerized system that allows a person, typically a telephone caller, to select an option from a voice menu and otherwise interface with a computer system. Generally the system plays pre-recorded voice prompts to the person, who then responds by pressing a number on a telephone keypad (touchtone) to select the option chosen or speaking simple answers such as “yes,” “no,” or numbers in answer to the voice prompts. When an IVR system is used to support a multi-line hunt, the IVR system can be used to inform the calling party that all available channels are busy and that the calling party has been placed in a queue. The IVR system may also be able to calculate an expected wait time and communicate this information to the calling party. For example, the IVR may transmit a pre-recorded message to the calling party that states, “We're sorry, but we're experiencing extremely high call volumes. Your call is important to us and will be answered in the order it was received. Your wait time is approximately <number here> minutes.”

The calling party may, however, find it inconvenient to remain on hold until a channel becomes free. For example, the calling party may have other phone calls to make or may need to perform other tasks that cannot be done (or are inconvenient to do) while holding. The inconvenience to the calling party increases as the hold time increases. For example, a calling party may be willing to hold for a few seconds but may become impatient or inconvenienced if the hold time stretches out to many minutes. Consequently, customers may become irritated or angry while they are on hold and, by extension, may develop a negative impression of both IVR systems and the companies that use them.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for queuing and returning calls in an interactive voice response system. The method may include storing information indicating a phone number of a calling party in response to the calling party initiating a call to a destination phone number that is a begin-hunt number for a hunt group including a plurality of channels. The method also includes providing a first message to the calling party in response to determining that the channels are busy. The first message indicates that the call to the destination phone number has been placed in a queue associated with the plurality of channels. The first message also indicates that the calling party can elect to receive a call-back at the stored phone number of the calling party when one of the channels becomes available.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a communication system that implements multi-line hunting, in accordance with the present invention; and

FIG. 2 conceptually illustrates one exemplary embodiment of a method of queuing and returning calls to a hunt group number, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

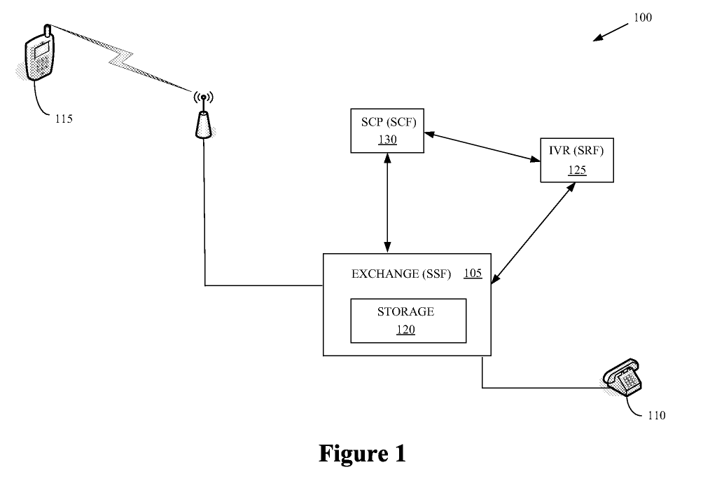

FIG. 1 conceptually illustrates one exemplary embodiment of a communication system 100 that implements multi-line hunting. In the illustrated embodiment, the communication system 100 includes an exchange 105 that includes functionality for supporting communication between one or more users and a multi-line hunting system. For example, the exchange may implement a Service Switching Function (SSF) that supports multi-line hunting. In one embodiment, the exchange 105 supports services such as Call Completion to Busy Subscriber (CCBS), which is a supplementary service whereby a user, upon encountering a busy signal, can issue a request to the network to start monitoring the busy subscriber, and for the network to call back the originating party as well as the previously busy party, as soon as the latter becomes available. The exchange 105 may also support caller line identification presentation (CLIP). The CLIP Supplementary Service provides the called party with the possibility to receive the line identity of the calling party. The network delivers the calling line identity to the called party at call set-up time, regardless of the terminal capability to handle the information. The exchange 105 may be implemented in hardware, firmware, software, or any combination thereof.

In the illustrated embodiment, the communication system 100 includes a multi-line hunt group 110. Although the multi-line hunt group 110 is represented in FIG. 1 by a single telephone, persons of ordinary skill in the art having benefit of the present disclosure should appreciate that the multi-line hunt group 110 typically includes numerous communication devices. The multi-line hunt group 110 may be contacted using a single telephone number (e.g., 1-800-ISPHELP) and then communication sessions with individual communication devices may be formed using individual channels of the multi-line hunt group 110. Techniques for implementing and operating multi-line hunt groups 110 are known in the art and in the interest of clarity only those aspects of implementing and/or operating the multi-line hunt group 110 that are relevant to the present invention will be discussed herein. Users may establish a communication session with individual communication devices within the multi-line hunt group 110 by calling the telephone number associated with the multi-line hunt group 110. In the illustrated embodiment, the user of a cellular telephone 115 may dial the contact telephone number of the multi-line hunt group 110, which may cause the cellular telephone 115 to transmit a setup message to the exchange 105. The setup message may include information indicating the number of the cellular telephone 115 (i.e. the calling party number), the number of the multi-line hunt group 110 (i.e., the called party number), as well as other information associated with the call session. The exchange 105 may then store the information in the setup message in a storage element 120 that may include various types of memory elements and may also implement a database. For example, the exchange 105 may determine that the cellular telephone 115 is attempting to form a communication session with a multi-line hunt group 110 and may store the setup message in response to this determination.

The exchange 105 may then attempt to form a communication session between the telephone 115 and one of the communication devices in the multi-line hunt group 110 using a free channel of the multi-line hunt group 110. If the exchange 105 determines that a free channel is available in the multi-line hunt group 110, e.g., using a sequential line hunt, then a communication session may be formed between the telephone 115 and a communication device in the multi-line hunt group 110 using the free channel. However, if all of the channels supported by the multi-line hunt group 110 are busy, then the exchange 105 may connect the telephone 115 with an announcement facility, such as an Interactive Voice Response (IVR) system 125 that supports a Specialized Resource Function (SRF). For example, the exchange 105 may transmit a request to initiate a connection to a Service Control Point (SCP) 130 that implements a Service Control Function (SCF). The SCP 130 may then establish a connection to the IVR 125, which may in turn establish a connection to the exchange 105 so that the IVR 125 can be used to transmit messages to the telephone 115.

The IVR 125 may request instructions from the SCP 130. In one embodiment, when all of the channels of the multi-line hunt group 110 are busy, the SCP 130 may instruct the IVR 125 to transmit an announcement to the telephone 115 and/or to collect information such as account information from the user of the telephone 115. For example, the IVR 125 may transmit an announcement that can be played to the user of the telephone 115 such as:
“We're sorry, but we are experiencing extremely high call volumes. Your call is important to us and will be answered in the order it was received. Your wait time is approximately <number here> minutes. Our system indicates you are calling from <calling party line ID>. If you would like us to call you back at that number when your hold time ends, press #1. Otherwise please continue to hold.”
   If the user of the telephone 115 wants to be placed in the queue for the multi-line hunt group 110 but does not want to remain on hold, then the user may press #1 on the keypad of the telephone 115 to indicate that the user would like to be called back when a free channel becomes available in the multi-line hunt group 110. If the IVR 125 detects that the user has entered #1, then the IVR 125 tells the SCP 130 that the announcement has been successfully played and that the digit #1 has been collected from the user.

The SCP 130 and the exchange 105 may then disconnect from the IVR 125. The SCP 130 may also instruct the exchange 105 to continue processing the call from the telephone 115. In cases where the user has indicated that they want to be placed on hold, the call attempt from the telephone 115 can be disconnected and then the recall request can be queued by the exchange 105. Once a channel of the multi-line hunt party 110 becomes available, the exchange 105 may retrieve the stored setup information and transmit that information to the telephone 115 along with information indicating that a free channel is available. The telephone 115 may then use this information to retry the original set up attempt. The exchange 105 then uses the retry information to establish a communication session between the telephone 115 and the appropriate communication device in the multi-line hunt party 110 using the free channel. For example, the exchange 105 may compare the calling party number in the new set up attempt from the telephone 115 to the numbers in the queue for the multi-line hunt party 110 to determine that the new set up attempt has been transmitted in response to a recall message and should therefore be directly connected to the free channel.

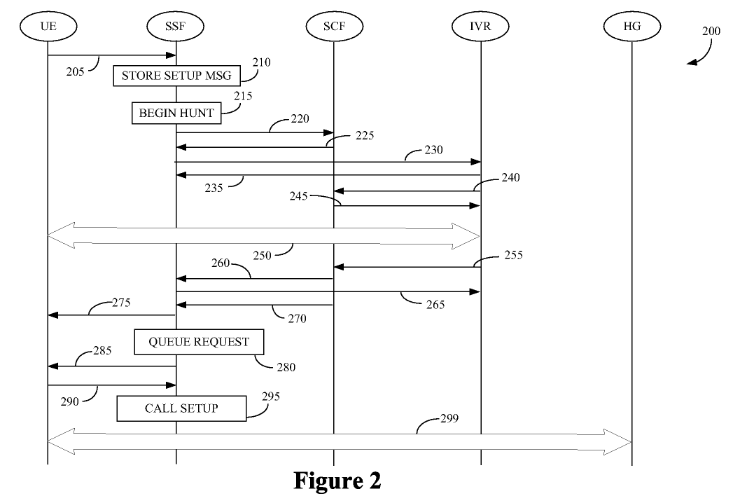

FIG. 2 conceptually illustrates one exemplary embodiment of a method 200 of queuing and returning calls to a hunt group number. In the illustrated embodiment, a user equipment (UE) initiates an attempted call to a hunt group (HG) by transmitting (as indicated by the arrow 205) a setup message to an SSF, which may be implemented in an exchange. The SSF stores (at 210) the setup message. For example, the SSF may determine that the user equipment has initiated a call to the hunt group and may store (at 210) a setup message in response to this determination. In one embodiment, the setup information may be stored according to CCBS procedures prior to establishing a CCBS subscription and also before the SSF has determined whether or not a busy condition exists at the hunt group. The SSF then begins (at 215) hunting for a free or idle channel supported by the hunt group. In the illustrated embodiment, the SSF determines that all of the channels supported by the hunt group are currently busy and so the SSF initiates an announcement procedure that is supported by an SCF and an IVR.

The SSF transmits (at 220) an initialization message to the SCF to request that the SCF begin the announcement procedure. For example, the SSF may transmit (at 220) a CAP InitialDP message to the SCF. The SCF may then setup a connection with the external IVR system by sending a CAP EstablishTemporaryConnection message to the SSF, as indicated by the arrow 225. The SSF and the IVR may then setup a connection by exchanging SetUp Request and SetUp Result messages, as indicated by the arrows 230, 235. Once the connection between the SSF and the IVR has been established, the external IVR system requests instructions from the SCF by sending a CAP AssistRequestInstructions message, as indicated by the arrow 240. The SCF may then provide instructions, as indicated by the arrow 245. For example, the SCF may request that the IVR transmit an announcement to the UE. The SCF may also request additional information, e.g., in the form of digits pressed on the keypad of the UE, by sending a CAP PromptAndCollectUserInformation message, as indicated by the arrow 245. For example, the SCF may request information indicating whether the user of the UE would like a call back when a free channel is available. For another example, the user of the UE may be prompted by the IVR to enter an account number or other details before “stepping into” the queue. An operator can therefore confirm the user's identity when the call session is established and begin providing the support service request instead of taking down this information all over again as if it were a new service call.

The announcement is played, and any requested information collected, at 250. In the illustrated embodiment, the IVR detects that the user of the UE has requested a call-back, e.g., by pressing #1 on the keypad. The IVR may then report (at 255) to the SCF that the announcement has played successfully and that the digit #1 was collected by sending it a CAP SpecializedResourceReport message. The SCF sends a request (at 260) to the SSF indicating that the SSF should disconnect from the external IVR (e.g., by sending a DisconnectForwardConnection message at 265). The SCF also instructs the SSF to continue the process (e.g., by sending a ContinueProcessing message at 270). Since the user has pressed #1, thereby indicating the desire to be called back as soon as a free channel to a support person becomes available, the call attempt from the user is disconnected by transmitting a disconnect message at 275.

At this point, the SSF queues (at 280) the recall request for the duration of the hold time. When the hold time ends and a free or idle channel becomes available, the SSF retrieves the stored SETUP message and transmits the retrieved information to the UE (at 285), e.g. using a CCBS Recall message. In one embodiment, presence and availability status of the user and/or UE may be factored in when determining when to transmit the recall message. For example, if the user is busy or temporarily unavailable, the recall may be re-scheduled for a later time when the user becomes available again. Upon reception of the recall message, the UE may unpack the recall message, per normal CCBS procedures, and use the un-packed message information to retry (at 290) the original call to the hunt group. The SSF may then set up (at 295) the communication session using the free channel and the call may be established between the UE and the available communication device in the hunt group (at indicated by the double arrow 299).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method, comprising:
storing information indicating a phone number of a calling party in response to the calling party initiating a call to a destination phone number that is a begin-hunt number for a hunt group including a plurality of channels;
providing a first message to the calling party in response to determining that the channels are busy, the first message indicating that the call to the destination phone number has been placed in a queue associated with the hunt group, the first message also indicating that the calling party can elect to receive a call-back at the stored phone number of the calling party when one of the channels becomes available.

2. The method of claim 1, wherein storing information indicating the phone number of the calling party comprises storing information contained in a setup message provided by the calling party.

3. The method of claim 1, comprising receiving, in response to the first message, information from the calling party requesting the call-back at the stored phone number of the calling party when one of the channels becomes available.

4. The method of claim 3, comprising retaining information indicative of the calling party in the queue and disconnecting the call session with the calling party in response to receiving the information requesting the call-back.

5. The method of claim 4, comprising determining that at least one channel is available.

6. The method of claim 5, comprising sending, to the calling party, a second message indicating that at least one channel is available in response to determining that at least one channel is available.

7. The method of claim 6, wherein sending the second message comprises sending information contained in a setup message provided by the calling party.

8. The method of claim 6, wherein sending the second message comprises sending at least one call-completion-to-busy-subscriber (CCBS) recall message.

9. The method of claim 6, wherein sending the second message comprises sending the second message at a time selected based upon at least one of a presence status and an availability status of the calling party.

10. The method of claim 6, comprising establishing a call session with the calling party over an available channel using information in the second message.

11. The method of claim 10, comprising:
requesting account information from the calling party prior to disconnecting the call session with the calling party;
storing received account information from the calling party; and
providing the requested account information to an operator over the available channel.
